(19) United States
(12) Patent Application Publication
(10) Pub. No.: US 2021/0091852 A1
(43) Pub. Date: Mar. 25, 2021

(54) ENHANCED LED SIGNALING STATUS FOR NETWORK DEVICE ONBOARDING

(71) Applicant: HEWLETT PACKARD ENTERPRISE DEVELOPMENT LP, Houston, TX (US)

(72) Inventors: PRAVEEN KRISHNAKUMAR PARANGATTIL, Bangalore (IN); MUBEESH ALI VARENGAL MOHAMMED, Bangalore (IN); TATHAGATA ROY, Bangalore (IN)

(21) Appl. No.: 16/576,557

(22) Filed: Sep. 19, 2019

(51) Int. Cl. H04B 10/116; H04B 10/114; F21V 8/00; G06K 9/00; H04L 12/26

(52) U.S. Cl. CPC H04B 10/116; H04B 10/1149; H04L 43/0817; G02B 6/0073; G06K 9/00671; H04B 10/1143

(57) ABSTRACT

Systems and methods that leverage visible light communication (VLC) through one or more visual indicators, such as light emitting diodes (LEDs), are provided. Control of such visual indicators provides encoded lighting patterns to be transmitted vis-à-vis the visual indicators in existing network devices and displayed in a straightforward and user-friendly format. In this way, sophisticated as well as unsophisticated users can be alerted to events during onboarding, such as software faults, configuration errors, and connection issues. The visual indicators are communicated in such a way that the lighting patterns can be embedded with detailed information concerning the status of the network device irrespective of network or console access. After decryption by the augmented reality (AR) device of the system, the detailed information is virtually displayed to the user enabling enhanced troubleshooting and remediation.

### DESCRIPTION OF RELATED ART

Device onboarding generally describes the process of bringing a device onto a network for the first time. The onboarding process encompasses multiple activities such as device provisioning, updating the configuration management database, verifying the correct functioning of the device, checking compliance with security requirements and so on, the orchestration of these steps can be quite complex. Additionally, onboarding new devices may include large numbers of network devices (e.g., access points, switches, routers, servers, etc.) with various components and configurations. Ideally, once the network device is activated, it performs to the specified expectations. To aid identifying issues during the onboarding process, traditionally hardware manufacturers include one or more visual indicators, such as light emitting diodes (LEDs), on a network device. Visual indicators may be some form of light source or form of display, e.g., a liquid crystal display (LCD). The status relayed is characterized through distinctive colors that coincide with broad indications such as green for connected and red for not connected or error. This allows an on-site user to visually identify a status of the device based on the color of the light source(s). Nevertheless, while general status information is provided through visual indicators, effectively resolving an error requires obtaining granular data from the device. Conventionally, the console port of the network device is used for this purpose because initially a network device does not have access to a network. That is, before commencing the onboarding process network devices are not connected to a network. A console port is used to connect a computer directly to a network device for monitoring and controlling the device when remote access is down. Thereafter, the user interprets totality of the information and addresses deficiencies in the onboarding process. An additional means to resolve network device issues mobile applications on smartphones. The camera of the smartphone scans machine-readable information located on the network device and transmits the converted information to remote databases that are used to identify the device. That is, a device unique identifier is acquired from the network device and sent to another location that contains detailed information on the device. Currently, the basic on-site visual information in conjunction with the advanced console port or off-site device data is essential for a user to effectively identify and tackle network device onboarding issues.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1A illustrates an example system in which visible light communication (VLC) can be implemented in accordance with one embodiment.

FIG. 1B illustrates the example system of FIG. 1 with greater specificity as applied to a single network device in accordance with one embodiment.

FIG. 2 is a flowchart of an example process for executing the system of FIG. 1 in accordance with one embodiment.

FIG. 3 illustrates an example light source control system in accordance with various embodiments.

FIG. 4 is a block diagram of an example computing component of a network device for determining a light source activation sequence in accordance with one embodiment.

FIG. 5 is a block diagram of an example computing component of an AR device for displaying the decoded status of the network device in accordance with one embodiment.

FIG. 6 is a representation of the relationship between the LED blinks/frequency, encoded status content, and time in accordance with one embodiment.

FIG. 7 illustrates an example computing component that may be used to implement various features of embodiments described in the present disclosure.

The figures are not exhaustive and do not limit the present disclosure to the precise form disclosed.

### DETAILED DESCRIPTION

As noted above, device onboarding entails executing and synchronizing multiple processes to bring new devices such as routers, switches, access points, and other elements into a network. The intricate and myriad processes as well vast number of various devices demand a sophisticated user to implement, navigate, and remediate the onboarding process. In an effort to simplify the process, autonomous devices and automated applications have been created. Autonomous devices self-monitor and indicate network device status by visual indicators such as LEDs. On the other hand, automated applications connect with network devices to provide specific operating conditions and tailored remediation solutions through a network backbone. The combination of general on-site status information and extensive off-site device data is the current standard for troubleshooting network devices during the onboarding process. However, the standard begins to break down when network or console access is lost. That is, network devices are unable to communicate with off-site resources to obtain advanced information about the network device. The presently disclosed technology overcomes said deficiency by using visible light communication (VLC) as a medium for transmitting advanced device information. VLC can be implemented in the existing hardware of network devices (i.e., light sources such as LEDs) and encoded optical messages are decoded by emerging AR technologies. The presently disclosed technology grants the ability to see what is happening within the network device while the network is down. For example, the network device's detailed status, error codes, and operating conditions can be displayed to the user in order to determine the root cause of issues. Thus, the usability of network devices as well as the user's experience during the onboarding process is optimized for performance in addition to convenience. Several advantages flow from the presently disclosed technology such as less expertise on premises for network onboarding and troubleshooting, implementation without any hardware changes, and a solution for onboarding troubleshooting when network devices fail to be identified by cloud-based monitoring platforms (e.g., Aruba® Central). Other advantages include utilizing a superior form of communication that does not require wires (i.e., VLC).

Onboarding describes the important process of getting a new device onto a network. Onboarding of infrastructure is often complex, time consuming, and requires a significant amount of resources. Consequently, complications commonly arise at some point in the process. For example, complications such as errors indicating fail to device provision, fail to device discovery, Dynamic Host Configuration Protocol (DHCP) failure, Domain Name System (DNS) error, not enough Power over Ethernet (PoE) power, fail to get device configuration, device connection failure, disconnected, network error (no-internet), provisioning info discovery failure, router invalid state, wrong password, WiFi disabled, incorrect SSID and/or security information, association rejection, authentication failure, unsupported authentication/encryption methods, incorrect network settings, etc. Existing systems transmit device information to cloud-based platforms, mobile applications, and dedicated software to appropriately resolve onboarding problems. However, said systems require network access to function properly. The presently disclosed technology provides the ability to transmit device information independent of network conductivity. Additionally, the transmitted information is presented in a format accessible and easy to understand for any user. The implementation of AR devices simplifies troubleshooting tasks by displaying status information of the network device in a straightforward and easy to understand context. Additionally, the rise of handheld AR is the tipping point for the technology being truly pervasive. Augmented reality libraries like ARKit®, ARCore®, MRKit®, have enabled sophisticated computer vision algorithms to be available for anyone to use.

As alluded to above, various embodiments seek to improve on the manner in which network device status and remediation information may be communicated to the user during the onboarding process. Traditionally, visual indicators, (such as LEDs), are used to provide low-level information about a network device. That is, visible colors signifying an issue exists and a broad category of the issue. For example, an LED for system status, an LED for radio status, and an LED for Ethernet status that emit designated colors based on whether the device is functioning. The user interprets the colors using associated status information provided by the hardware manufacturer. Thus, LEDs provide a means to quickly assess the network device's status, but more in-depth data of the network's device status is required for addressing the pending issue. The in-depth data containing network device operating conditions and error codes is provided by gaining access to the inner workings of the network device. Normally, this can be done effectively through wired (e.g., console cable) or wireless connections (e.g., cloud-based network monitoring) but the ability of network devices to communicate wirelessly with other devices can be hindered or even lost due to various configuration and hardware errors. Moreover, during the initial stages of onboarding, network devices do not have access to any network, so a wired connection is paramount to the network device onboarding process. A wired network is formed by connecting the console port of the network device with the serial port of a computer through a serial or console cable. Thereafter, the network device can communicate with the computer regarding operating conditions, error codes, and detailed status information. If desired, the computer can transmit this information to remote databases for further analysis and troubleshooting. For example, complex problems with network devices that need the guidance of network technicians or administrators.

Therefore, the presently disclosed technology seeks to remedy this common scenario by providing systems and methods that enhance the user's ability to troubleshoot network device failures. Augmented reality (AR) is an emerging technology that leverages existing components in smartphones such as sensors, cameras, processors, and displays in conjunction with AR computer processing techniques to depict the real world and virtual world simultaneously. For example, taking an image of a marker (e.g., OR code) with a smartphone outputs computer-generated perceptual information superimposed on the taken image. The overlaid sensory information enhances natural environments and offers perceptually enriched experiences. In the presently disclosed technology, a light source activation sequence embedded with supplementary information may act like a “marker” that, when scanned by the AR device (e.g., smartphone), displays the supplementary information overlaid on the scanned image. The supplementary information can include network device status, network device operating conditions, network device failures, network device errors, network device type, network device make, network device model, and network device troubleshooting/remedial guidance. It should be understood that as used herein, the term “interface,” “interface unit,” or “component” can refer to any electronic or mechanical device used in the connection with operating a network device. This may include, but is not limited to, traditional network device hardware and software, network device interfaces, etc.

Accordingly, various embodiments provide a processor of a network device that can control or manipulate one or more visual indicators, as desired, to generate signals, alerts, or other notifications. It should be understood that such visual indicators are generally implemented as LEDs, but various embodiments disclosed herein contemplate any type of visual indicator associated with network devices as disclosed in this context. Thus, although various embodiments are described as controlling one or more hardware LEDs, various embodiments are also capable of controlling other types of visual indicators. In this way, users, administrators, or other personnel can be alerted to events impacting hardware and software units, and can also be directed to a component actually at issue. In some embodiments, a combination of LEDs or a particular light source activation sequence involving one or more LEDs can signify different events, types of events, direct user to a particular fault unit, etc. Especially in the case of multiple LEDs, embodiments provide the ability to control LEDs simultaneously or in some desired sequence to signify one or more events.

In particular, an operational check of all (or subset(s) of all) hardware, software, and interface units within a network device or similar environment can be determined. A coordinate map can also be generated or determined, and a correlation between the status of the network device and a light source activation sequence can be made. In this way, the processor of the network device is aware of what light source activation sequence may need to be emitted in order to effectively depict a network device status. Moreover, because of this determined correlation, the light source activation sequence can be generated or planned in an agnostic fashion with regard to the network device. That is, it does not matter which or what network devices are present as the processor of the network device need only be concerned with whether or not a particular LED pattern that corresponds to a particular condition should be enabled/activated, and how that enablement/activation occurs. It should be understood that the examples discussed above and the examples that follow are not meant to be limiting. It should also be understood that the activation (and/or deactivation) of one or more LEDs may be triggered by one or more policies applicable to a particular network device.

According to various embodiments of the disclosed technology systems and methods for network devices to communicate status information that may include errors through a LED sequence. The status of the network device may be monitored in near real-time and the lighting pattern is updated in accordance with the current status of the network device. Moreover, the status information can be communicated irrespective of a network connection. For example, a changed status in the network device from a network connectivity issue to an authentication failure can be optically transmitted to another device. The light pattern may be decoded by another device (e.g., smartphone) that is capable of employing augmented reality (AR) technologies. The decoded status information can be used by the user of the mobile device to address possible deficiencies detected by the onboard processor of the network device. The various embodiments include:

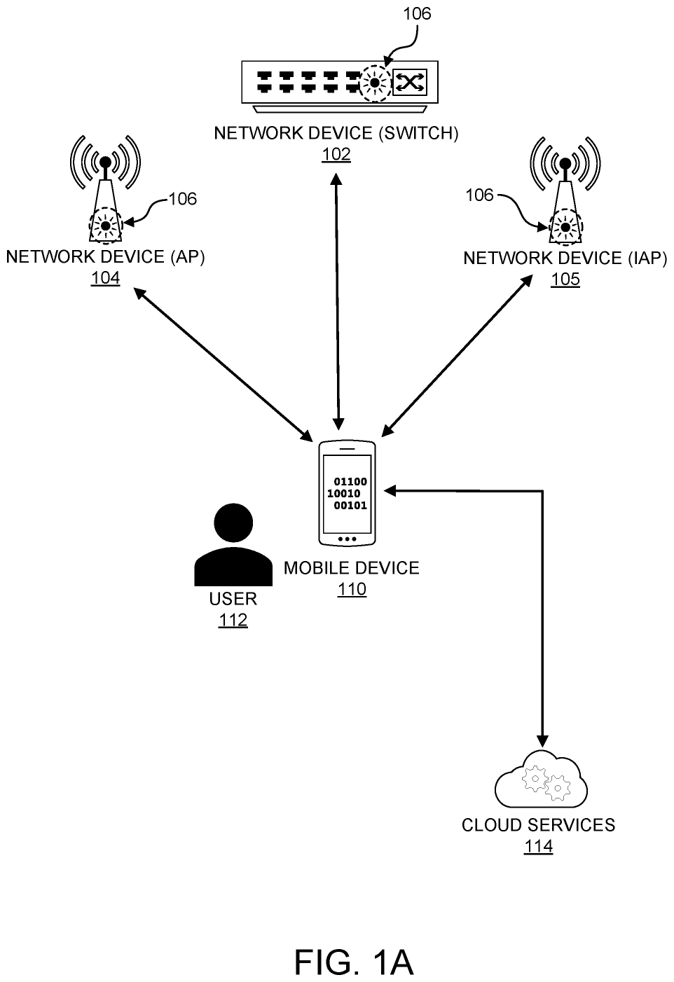

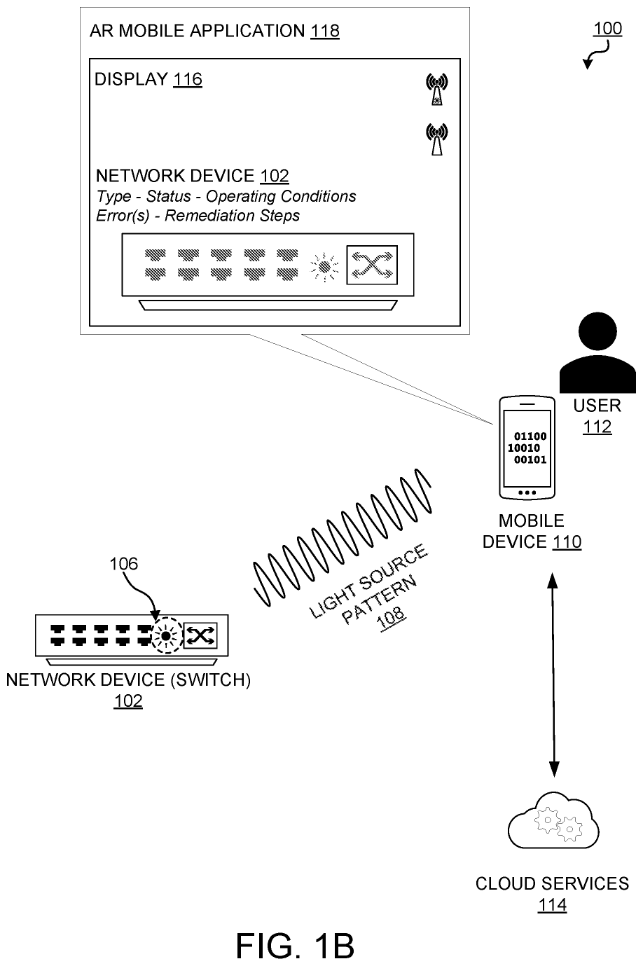

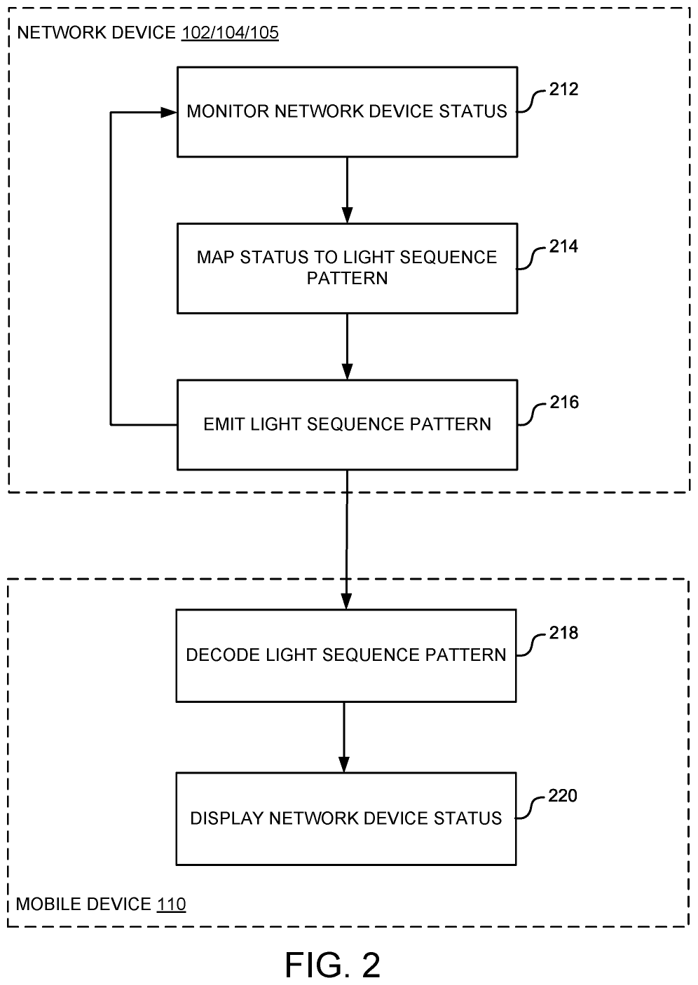

FIGS. 1A and 1B illustrate certain aspects an example system in which visible light communication (VLC) can be implemented in accordance with one embodiment of the presently disclosed technology. It should be understood that access points, instant access points, and switches are merely examples of network devices which various embodiments may be implemented. It is contemplated that various embodiments are implementable in other types or configurations of networks and network devices. Network devices 102, 104, and 105 depict a switch, access point, and instant access point, respectively. Each network device includes at least visual indicator illustrated by light source 106. The light source 106 may include a LED or a plurality of LEDs. The light source 106 may be controlled in certain situations to convey meaningful messages and status to a user. That is, each light source 106 is controlled by a respective processor, such as an embedded module, of the component upon which the light source 106 is positioned. In the illustrated embodiment of FIG. 1B, the desired light source activation sequence is depicted by the light source pattern 108. The light source pattern 108 transmitted is encoded with supplementary information related to the status 212 (See FIG. 2) of the network device. For example, the general state of the network device, the operating conditions of the network device, and, if any, errors in the network device and corresponding remediation steps. Consequently, substantial amounts of information are wirelessly transmitted in a simple and efficient manner independent of network access.

In some embodiments, network devices 102, 104, and 105 may be a part of a network onboarding process in which said network devices do not have access to a network or console. That is, network devices 102, 104, and 105 are unable to effectively communicate, through conventional means, advanced status and curative information. The presently disclosed technology overcomes this deficiency by utilizing VLC. For example, FIG. 1B illustrates an emitted light source pattern 108 received by a mobile device 110 such as a smartphone. The components in conventional smartphones satisfy the sampling requirements necessary to successfully capture and decode the light source pattern 108. Nevertheless, while smartphones are a convenient means to receive and interpret encoded visible light communication; alternative devices that include means to implement AR technology may also be used (e.g., heads up displays, holographic displays, smart glasses, etc.). For ease of discussion, the technology disclosed herein shall be discussed with respect to an implementation utilizing a mobile device, but this should not be interpreted as limiting the scope of the present disclosure to only such implementations.

In some embodiments, the mobile device 110 is directed towards the light source 106 by the user 112 to capture the light source pattern 108. As mentioned above, the light source pattern 108 is encoded with additional information that the mobile device has the capability to detect and decode using advanced AR technologies such as computer vision and object recognition. In one embodiment, the duration of time the user 112 directs the mobile deceive 110 lasts mere seconds (e.g., four) to decipher the payload embedded in the light source pattern 108. As illustrated in the example embodiment of FIG. 1B, once the light source pattern 108 is decoded, the payload (e.g., detailed status information) of the VLC is displayed to the user in a straightforward and assessible format. Specifically, an augmented reality mobile application 118 run by the mobile device 110 can display the network device status information overlaid a real-world image of the network device. The display 116 includes the network device currently being analyzed, network device 102, as well as previous network devices assessed by the system 100. The AR mobile application 118 has the functionality to generate texts or graphics representing detailed status information superimposed on an image of the network device in the display 116. This functionality can be done automatically by the AR mobile application 118 and, optionally, digitally manipulated by the user. For example, in response to determining the network device 102 (See FIG. 1B) has an Ethernet port error, the AR mobile application 118 can superimpose “→ ERROR ←” on the Ethernet port of the inputted real-world image of the network device 102. Note, any combination of text, colors, or symbols can be used to effectively communicate the type and location of the error to the user. Moreover, in addition to displaying the type and location of errors, the AR Mobile Application can also display steps to correct the errors. As to the example above, after exposing the Ethernet port error, the AR Mobile Application 118 may generate a list of steps on the display 116 such as:
1. Replace Ethernet cable. If error persists,
2. Manually configure speed/duplex settings by XXX. If error persists,
3. Contact User Support for further troubleshooting assistance: XXX-XXX-XXXX or XXX.com.

Once again, any combination of text, colors, or symbols can be used to efficiently guide the user through the troubleshooting process.

In an alternative embodiment, the mobile device 110 displays the status information to the user and also transmits the information to cloud-based services 114 (e.g., Aruba® Central). For example, if the display of the AR Mobile Application 118 dictates to contact user support, information and error codes are automatically transmitted to a site for remote management. The status information can be transmitted regardless of any errors that are deciphered by the AR Mobile Application 118 and useful for quickly identifying the network device if further updates are needed.

FIG. 2 is a flowchart of an example process for executing the system of FIG. 1 in accordance with embodiments disclosed herein. The flowchart illustrates the respective functions performed by the network device 102/104/105 and the mobile device 110. With reference to FIG. 2, at operation 212 the network device autonomously assesses status information. The status information at the least may include the general state, operating conditions, errors, and failures of the network device. The monitored status information is used to select the appropriate light sequence pattern based on a stored preestablished relationship between statuses and light sequence patterns at operation 214.

At operation 216, the selected light sequence pattern is emitted or transmitted by the embedded light source 106 of the network device. The light sequence pattern is continuously emitted until a change is status is detected at which point the network device repeats operations 212, 214, and 216.

At operation 218, the mobile device 110 receives the light sequence pattern and decodes the status information encoded within. The mobile device 110 at the least may include a camera, processor, sensors, and a display, Additionally, the processor of the mobile device is capable of executing AR technologies such as computer vision and objection recognition to accurately identify and decipher the light sequence pattern.

Lastly, at operation 220, the mobile device 110 displays the decoded light sequence pattern in human readable format. The decoded light sequence pattern revealing status information as well as possible curative information about the network device. The mobile device 110 employs an AR display that combines the generated status information with a real-world image of the network device. The combination of actual and computer generation text/graphics enhances the status information eventually displayed to the user for troubleshooting analysis.

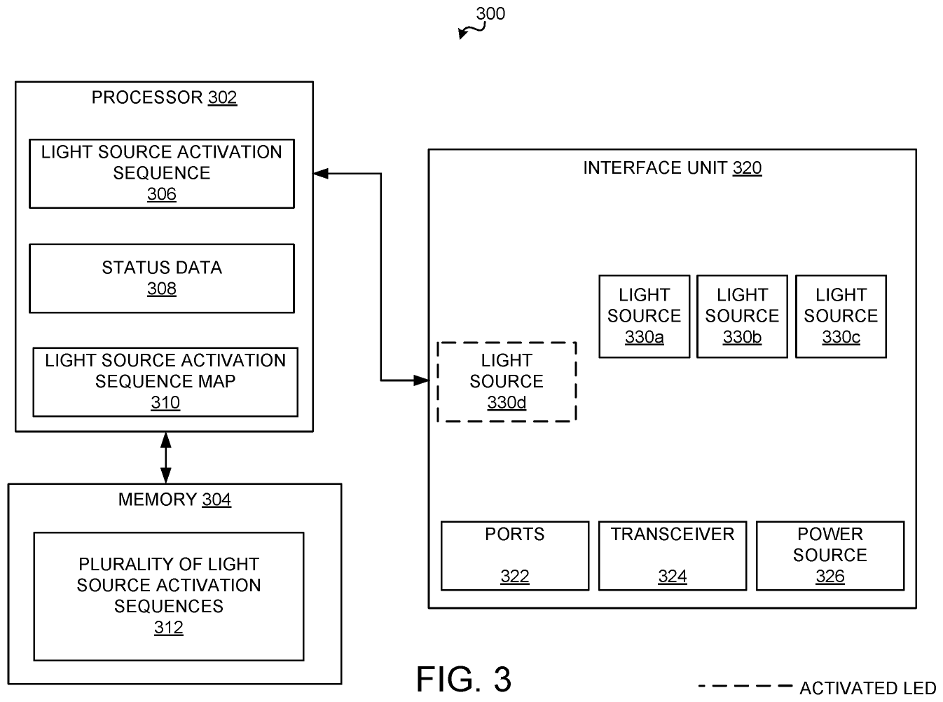

FIG. 3 illustrates an example light source control system 300 that is implemented within network devices 102, 103, and/or 105. In some embodiments the system 300 may include an embedded processor 302 that is used to monitor and/or control operations of the network device. For example, processor 302 may be in an example embodiment the dedicated processor of a network device such as a switch, instant access point, or wireless router. In some embodiments, processor 302 may be an embedded processor of an access point that can be managed in unison with remote controllers as well as an autonomous mode without a controller. Basically, the embedded processor 302 of the access point establishes a secure connection between devices, orchestrates access to a network, and continuously monitors the status of the access point. Interfaces of the access point may include LEDs that provide rudimentary status information of the Ethernet link, radio connection, and power source such as operational or not. In this embodiment, the dedicated processor and LEDs of the access point can be utilized to determine and emit a dynamic light source activation sequence embedded with detailed access point status information.

Operating in conjunction with the processor 302 may be a memory unit 304 in which a plurality of light source activation sequences are stored. The light source activation sequence map 310 may comprise a linkage between a plurality of light source activation sequences and associated statuses/states of the network device. Example statuses/states comprise fail to device provision, fail to device discovery, DHCP failure, fail to get device configuration, device connection failure, disconnected, network error (no-internet), provisioning info discovery failure, router invalid state, wrong password, WiFi disabled, incorrect SSID and/or security information, association rejection, authentication failure, unsupported authentication/encryption methods, incorrect network settings, etc. While error states are provided as examples above, status information concerning elements that are functioning properly is also provided. As to the light source activation sequence map 310, each status has a corresponding light source activation sequence. For example, a simple sequence of 25 blinks/s is linked to the status of a certificate authentication failure. Since a high-resolution camera is used to capture the light source activation sequences a tremendous amount of light source activation sequences are available to be associated with a precise status. The tremendous amount of light source activation sequences designated as plurality of light source activation sequences 312 in FIG. 3 are stored in the memory unit 304 for recall by the processor 302. The selected light source activation sequence 306 may be based on the associated status as determined by the processor 302 of the network device 102/104/105. In an embodiment where the processor 302 continuously monitors the state of the network device. The processor 302, after acquiring status data 308, refers to the light source activation sequence map 310 to determine the appropriate light source activation sequence for the status data 308. Once the appropriate light source activation sequence is determined, the processor 302 retrieves said light source activation sequence from the memory 304. Then, processor 302 executes the light source activation sequence 306 which transmits said light source activation sequence 306 to one or more light sources 330a-d of the interface unit 320. Lastly, at least one light source of the plurality of light sources 300a-d emits the light source activation sequence 306.

The selected light source activation sequence 306 can be emitted by one or more light sources of the network device. As illustrated in FIG. 3, a single light source 330d emits the light source activation sequence selected by the processor 302. However, it may be determined that a plurality of light sources 330a-d should be sequentially activated to encode multiple levels of information with increasing granularity, such as a first light source transmitting crude status information and, subsequently, a second light source providing specific parameters in relation to the crude status information. Moreover, light sources and their respective locations may be designated to communicate certain types of information. For example, a first light source indicating a preamble of an activation sequence (i.e., notice that the substantive status information is forthcoming), a second light source indicating substantive status information, and a third light source indicating remediation information.

It should be noted that the processor 302 may detect any events occurring across the network device, including an interface unit 320. In response to detecting a change in status of the network device, it may be determined that a light source activation sequence should be activated. The light source activation sequence is mapped to the corresponding event or changed status of the network device. In some embodiments, a light source activation sequence 306 may be specified in terms of the type and nature of the detected event.

In an alternative embodiment, status information about the network is continuously transmitted while the network device is powered on. That is, the light source of the network device is always on and capable of being communicated with. Thus, the mobile device 110 can receive and decode status information regardless of the current status of the network device as long as the network device has not been switched off. This allows the user to review the detailed status and operating conditions of operative and non-operative network devices.

As alluded to above, an interface unit, such as interface unit 320 may include various ports 322, a transceiver 324, internal power source 326, and multiple light sources, including (as shown in FIG. 3) a plurality of LEDs (light sources 330a-d); however, any light source capable of encoding advanced status information through high frequency blinks may be used. Controlling light sources 330a-d, may include transmitting RGB values, intensity values, blinking frequency, pattern, etc. according to which light sources 330a-d should be active.

In accordance with some embodiments, light sources may comprise tri-color LEDs capable of displaying various different colors, where three physically discrete LEDs may be positioned proximate to one another in a single assembly. Each of the LEDs can be capable of providing light at a fixed number of lumens (perceived brightness) and at a fixed wavelength (perceived color, i.e., red, blue, green) in various embodiments. When the three discrete LEDs are lit, the perceived color can be bright white, when one of the three discrete LEDs is lit, e.g., a red LED, while the green and blue LEDs are not lit, the perceived color can be a pure red, and so on.

The creation of assorted colors can be achieved by fluctuating the percentage of time that each of the three discrete LEDs (also referred to as a “sub-LED”) is actually lit. For example, activating a blue sub-LED 100% of the time, a red sub-LED 50% of the time, while a green sub-LED is inactive (or active 0% of the time) yields a dark purple. Accordingly, depending on a desired lighting sequence, various sub-LEDs of a light source may be controlled to activate/deactivate, remain active, remain inactivate, etc. for a desired period of time. For example, a desired lighting sequence may involve lighting a particular light source to a purple color for 10 seconds. Accordingly, processor 302 may activate light source 330a (which may be a tri-color LED) such that the blue sub-LED of light source 330a is active for the entire 10 seconds, and the red sub-LED of light source 330a is active for 5 seconds.

Pulse-width modulation (PWM) may be used to translate or convert a desired percentage of time into actual pulsing of the sub-LEDs from on to off. For example, if a red sub-LED is to be active 100% of the time during which the LED is to be active, a cycle time of 1/100 of a second can be used meaning that 100 times in one second, the red sub-LED can be active/lit. Conversely, if a desired lighting sequence involves activating a red sub-LED for only one percent of the time during which the light source is to be active, an activation pulse is transmitted to the red sub-LED once out of every 100 clock ticks. It should be understood that the light source will still appear red, but dimmer to the human eye. In other words, LEDs or sub-LEDs can be pulsed according to a “width” that equates to the number of times an LED/sub-LED is activated versus the number of times the LED/sub-LED is inactive. Alternatively, in some embodiments, the control commands can be specified just as frequency settings, e.g., 15 blinks/second.

As an example, processor 302 determines the appropriate pattern for the light source activation sequence. The light source activation sequence can include a preamble to indicate the start of the substantive status information. The preamble may be a predetermined frequency of blinks and/or color. An example of frequency values and associated states is shown in Table 1 below:

TABLE 1

| FREQUENCY | STATUS |
|---|---|
| 10 blinks in a second | Not Getting DHCP IP Address |
| 15 blinks in a second | Device Not Able To Reach Activation |
| 20 blinks in a second | Not Able To Resolve The DNS |
| 25 blinks in a second | Certificate Authentication Failure |
| 30 blinks in a second | Ethernet Port Error |
| 35 blinks in a second | License Not Assigned In Central Network |
| 40 blinks in a second | Not Enough Power In PoE |
| 50 blinks in a second | AP Not Mapped To Any Account In Activation |

As alluded to above, various embodiments are directed to providing light source activation sequences, which in some embodiments may comprise a preamble which lets the receiver or camera know the substantive message will start immediately after. Accordingly, in some embodiments, an example of a preamble is as follows:

{

“Red”: 100,
“Green”: 100,
“Blue”: 100,
“Intensity”: 100,
“DurationMS”: 3000

}

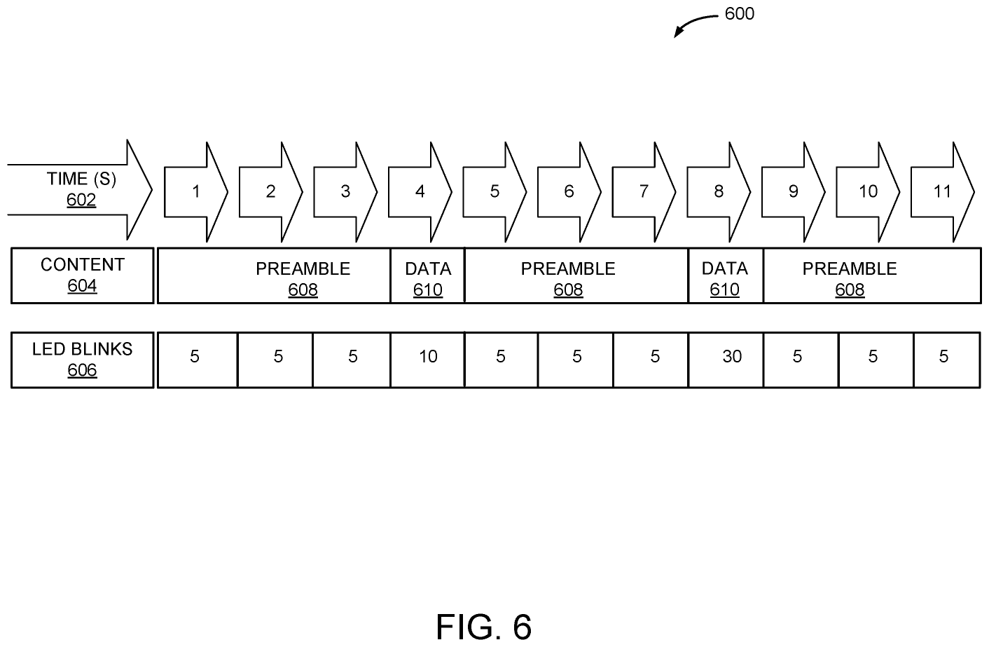

The duration value can specify to the processor how long (in this example, 3000 milliseconds (MS) or 3 seconds) to display a given RGB color at a given intensity before deactivating the LED/sub-LED. In some embodiments, the LEDs can utilize a predetermined frequency with a fixed color. As shown in FIG. 6, the LEDS can emit a repeated pattern of five blinks per one second and may be a fixed desired color. Alternatively, in other embodiments the LEDs are identified through both frequency and color. The specifics of the preamble may vary throughout the embodiments provided as long as the camera of the mobile device 110 is able to differentiate the preamble from the substantive status information. Nevertheless, incorporating color schemes into the preamble is one of the simplest and robust means to do so.

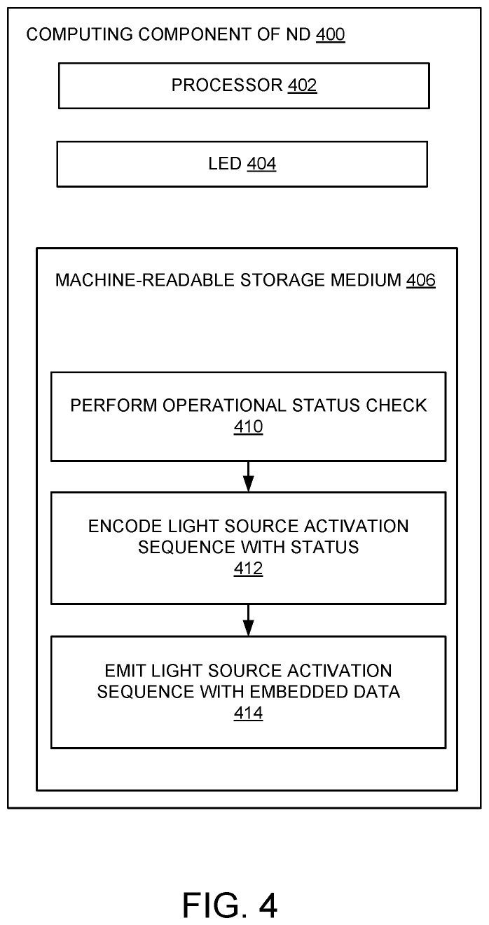

FIG. 4 is a block diagram of an example computing component of the network device 400 for controlling one or more light sources of one or more hardware units in the network device in accordance with one embodiment. Computing component 400 may be, for example, a switch, access point, router, or any other similar computing component that undertakes the process of onboarding. In the example implementation of FIG. 4, computing component 400 includes a processor 402, and machine-readable storage medium 406. In some embodiments, computing component 400 may be an embodiment of an instant access point, Aruba® 110 series Access Points, for example.

Processor 402 may be one or more central processing units (CPUs), semiconductor-based microprocessors, and/or other hardware devices suitable for retrieval and execution of instructions stored in machine-readable storage medium, 406. Processor 402 may fetch, decode, and execute instructions to control processes or operations for controlling one or more LED(s) 404 in accordance with one embodiment. As an alternative or in addition to retrieving and executing instructions, processor 402 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 406, may be any electronic, magnetic, optical, or other physical storage device that contains or stores executable instructions. Thus, machine-readable storage medium 406 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 406 may be a non-transitory storage medium, where the term “non-transitory” does not encompass transitory propagating signals. As described in detail below, machine-readable storage medium 406 may be encoded with executable instructions. Machine-readable storage medium 406 may be an embodiment of memory 304 of FIG. 3.

Processor 402 may execute instructions encoded in machine-readable storage medium 306 to assign a blinking frequency to each light source of each of a plurality of light sources. As noted above, a light source may comprise a single LED, a multi-color LED, such as a tri-color LED, an LCD, or other light source. In this way, a desired lighting sequence can be achieved regardless of what light source(s) of a network device may be activated. That is, and as discussed with respect to FIG. 4, a light activation sequence can be specified or set forth based on status information of the network device.

Processor 402 may execute instruction 410 to perform an operational check of the network device. The operational check is conducted to assess the current operating condition of the network device including any issues if present. Once the status of the network device is determined, the processor of the network device 402 executes the instruction 412 to encode a light source activation sequence. The light source activation sequenced is encoded by mapping the light source activation sequence to one or more patterns in accordance with the associated status. That is, with the status identified and an animation selected or determined, coordinating the actuation of light sources that play-out the animation is performed next. That is, a series of light source control commands is generated by the processor 402 that correspond to the desired lighting sequence at the desired pattern.

Processor 402 may execute instruction 414 to calculate a light source activation sequence. In some embodiments, processor 402 may dynamically determine an appropriate lighting sequence based on a particular event(s) sensed or determined by processor 402, e.g., a mapping or correlation between hardware/software component condition and some set of animations or combinations of sets of animations. That is, and during runtime, depending on the type of event or condition sensed by processor 402, a detailed status of the network device may be identified for a particular animation. For example, this could be a hardware component that is experiencing a fault or that otherwise requires customer or user attention. For example, a “device failed” notification or determination by processor 402 may be associated with a particular blinking frequency. Lastly, hardware processor 402 may execute instruction 414 to initiate the light source activation sequence. This may comprise various rates and combinations of blinks in a short period of time. As shown above, example light source activation sequences are demonstrated in Table 1.

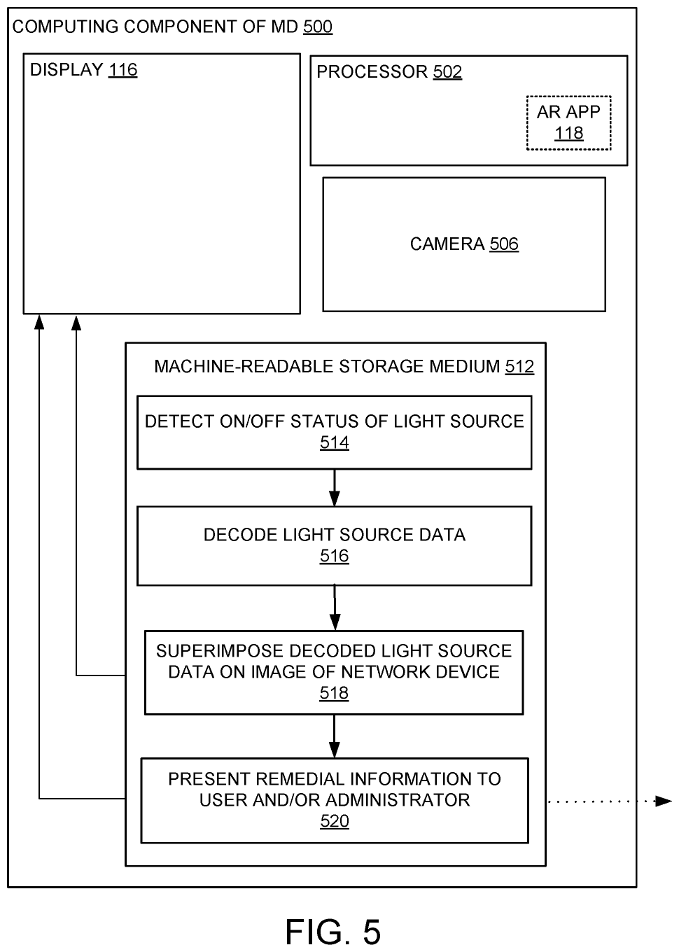

FIG. 5 is a block diagram of an example computing component of the mobile device 500 for receiving an optical transmission from a network device and thereafter displaying a readable status and corresponding remedial data messages in accordance with one embodiment. Computing component 500 may be, for example, a smartphone, tablet, or any other similar computing component capable of employing augmented reality (AR) technologies. Over devices that incorporate AR technology are heads up displays (HUDs), holographic displays, and smart glasses which could be used in an embodiment of the presently disclosed technology. In the example implementation of FIG. 5, computing component 500 includes a processor 502, and machine-readable storage medium 406. In some embodiments, computing component 500 may be an embodiment of a mobile phone processor using an augmented reality mobile application, Aruba® Installer™ mobile app, for example.

Processor 502 may be one or more central processing units (CPUs), semiconductor-based microprocessors, and/or other hardware devices suitable for retrieval and execution of instructions stored in machine-readable storage medium, 506. Processor 502 may fetch, decode, and execute instructions to control processes or operations for detecting and decoding one or more light source patterns in accordance with one embodiment. As an alternative or in addition to retrieving and executing instructions, processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 512, may be any electronic, magnetic, optical, or other physical storage device that contains or stores executable instructions. Thus, machine-readable storage medium 512 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 512 may be a non-transitory storage medium, where the term “non-transitory” does not encompass transitory propagating signals. As described in detail below, machine-readable storage medium 512 may be encoded with executable instructions. Machine-readable storage medium 512 may be an embodiment of memory in a standard smartphone (e.g., LG® Nexus 5x, Huawei® Nexus 6P, and iPhone® X).

Processor 502 may execute instructions encoded in machine-readable storage medium 512 to detect the on/off status of the light source 514. In one example, the optical connection is formed by executing an AR mobile application in conjunction with focusing the camera 506 on the light source (e.g., LED 404) for a predetermined duration of time. Once the light source is detected, the camera 506 in the mobile device 500 senses the light source activation sequence which comprises one or more rapid flickering LEDs that contain a pattern imperceptible to the human eye. The camera 506 may be capable of capturing high resolution frames. Commercial-Off-The-Shelf (COTS) smartphone models with Complementary Metal-Oxide Semiconductor (CMOS) cameras can be used which have to ability to sense 30-240 frames per second (e.g., LG® Nexus 5x, Huawei® Nexus 6P, and iPhone® X). In some embodiments, focusing the camera on the light source activation sequence for as little as four seconds is sufficient for acquiring the status information of the network device. The AR mobile application implements computer vision and an image processing routine (e.g., augmented reality libraries like ARKit®, ARCore®, MRKit®) on the frames captured by the camera 506 to detect and display the emitted LED pattern in the appropriate context. Specifically, one example of a means to encode and decode the blinking LEDs include On-Off Keying (OKK), in which LED status on/off represents bit 1/0. OOK modulates a frame in a single time slot and thus does not have sample rate requirement. A camera or receiver only needs to capture instantaneous LED statuses to perform demodulation and recover the frame. Data modulation can be used to lower the LED working frequency (i.e., higher frequencies result in errors or frame mixing) required for imperceptible transmission. Once the light sequence activation pattern is deciphered into human readable information 516, the information is displayed, in the appropriate content (e.g., overlaid an image of a network device), on the display of the mobile device 518. The AR mobile application may also provide corresponding steps to remediate a status indicating an error on the display of the mobile device 520.

FIG. 6 is a representation 600 of the relationship between the LED blinks/frequency 606, encoded status content 604, and time 602 in accordance with one embodiment. The LED blinks 606 may be a whole number depicting the number of blinks in one second. The content 604 may be the data transmitted by the LED blinks 606 comprising both preamble 608 and status message or data 610 information. The preamble 608 is used to indicate the start of each status message transmitted, guide the mobile device 110 to the locations of status information, and prompt the mobile device 110 of an imminent status message.

In the illustrated example, the preamble 608 has a duration of three seconds, a constant color (e.g., yellow), and at a rate or frequency of five blinks (i.e., on/off of LED) per second. The frequency or rate (i.e., five blinks/second) is repeated three times to clearly distinguish the preamble from the status message or data 610. Thus, the duration of the preamble immediately preceding the data is three seconds and contains fifteen blinks. While a fixed color with a constant rate is emitted in this example, alternative embodiments can employ various color schemes to aid in the identification of the preamble. The color modification of LEDs described in greater detail above.

The status message or data 610 sequentially follows the preamble 608 in the illustrated embodiment. As shown, the data 610 has a duration of one second and contains various blinks corresponding to the monitored status of the network device. For example, referring to Table 1 above, the first error message “Not Getting DHCP IP Address” is transmitted to the mobile device 110 and the second error message “Ethernet Port Error” is also transmitted to the mobile device 110. The network device 102/104/105 can continuously transmit the status conditions whether the same or changing. The particular blinking frequency and color pattern based on the relationship established by the light source activation sequence map 310.

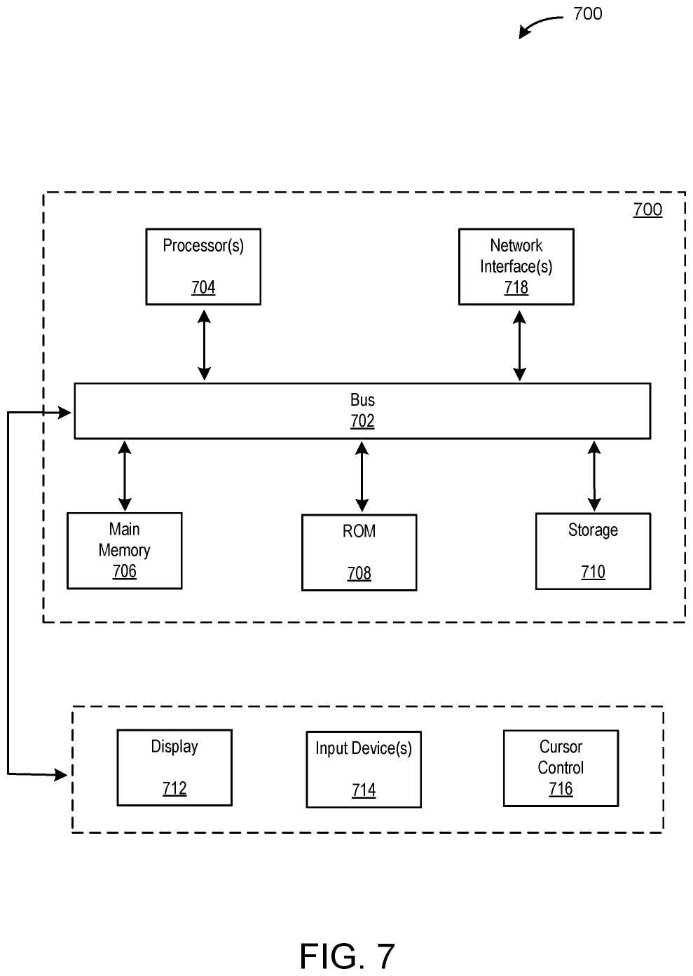

FIG. 7 depicts a block diagram of an example computer system 700 in which various of the embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions. Also coupled to bus 702 are a display 712 for displaying various information, data, media, etc., input device 714 for allowing a user of computer system 700 to control, manipulate, and/or interact with computer system 700. One manner of interaction may be through a cursor control 716, such as a computer mouse or similar control/navigation mechanism.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some embodiments, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

The computer system 700 also includes a communication interface 718 coupled to bus 702. Network interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or WAN component to communicated with a WAN). Wireless links may also be implemented. In any such implementation, network interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 718, which carry the digital data to and from computer system 700, are example forms of transmission media.

The computer system 700 can send messages and receive data, including program code, through the network(s), network link and communication interface 718. In the Internet example, a server might transmit a requested code for an application program through the Internet, the ISP, the local network and the communication interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another or may be combined in numerous ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

1. A method comprising:
monitoring, via a processor of a network device, a status of the network device containing at least one light source;
mapping, by the processor, the status of the network device to a light source activation sequence of a plurality of light source activation sequences, each light source activation sequence comprising a pattern configured to encode a message defining the status on a light signal emitted by a modified light source;
applying, by the processor, the light source activation sequence associated with the status to the at least one light source of the network device such that the at least one light source emits the pattern of the light source activation sequence; and
in response to detecting a changed status of the network device:
identifying, by the processor, an updated light source activation sequence, the updated light source activation sequence associated with the changed status; and
applying, by the processor, the updated light source activation sequence associated with the changed status to the at least one light source of the network device such that the at least one light source emits a pattern of the updated light source activation sequence; and
wherein the pattern of each light source activation sequence includes one or more of a blinking frequency and a color pattern.

2. The method of claim 1, wherein the network device comprises a plurality of light sources, the method further comprising determining, by the processor, one or more light sources of the plurality of light sources to which to apply the light activation sequence associated with the status of the network device.

3. The method of claim 1, wherein the light source activation sequence comprises activating, by the processor, the at least one light source for a predetermined duration of time.

4. The method of claim 2, wherein the one or more light sources comprise light emitting diodes.

5. The method of claim 1, wherein the mapping, by the processor, the status of the network device to the light source activation sequence occurs in response to detection of one or more events associated with the network device.

6. The method of claim 1, further comprising the pattern of each light source activation sequence includes a preamble and the status of the network device, wherein the preamble precedes the status of the network device.

7. The method of claim 6, wherein the preamble comprises a color pattern and at least a duration of three seconds;
wherein the status of the network device sequentially follows the preamble.

8. The method of claim 1, wherein the message defining the status of the network device comprises information indicating at least one of a network connectivity status, authentication failure, port error, power failure, outdated software, configuration issue, and hardware malfunction.

9. The method of claim 1, wherein the network device comprises at least one of an access point, instant access point, and network switch.

10. The method of claim 1, wherein the pattern of the light source activation sequence is undetectable to the human eye.

11. The method of claim 1, wherein the at least one light source emits the pattern of the light source activation sequence comprises the processor applying the light source activation sequence continuously upon activation of the network device.

12. The method of claim 1, wherein the status of network device comprises operating conditions, error conditions, and infrastructure conditions.

13. A method comprising:
monitoring, via a processor of a network device, a status of the network device containing at least one light source;
encoding, by the processor, the status of the network device with the at least one light source wherein the at least one light source comprises a blinking pattern undetectable to the human eye;
establishing an optical connection between the network device and a mobile device with the at least one light source;
communicating the encoded status of the network device to the mobile device through the optical connection; and
in response to the processor detecting a changed status of the network device:
encoding, by the processor, the changed status of the network device with the blinking pattern of the at least one light source; and
communicating the encoded changed status of the network device to the mobile device through the established optical connection; and
wherein the status and the changed status of the network device is monitored, by the processor, continuously.

14. A method comprising:
sensing a light source activation sequence of a network device with a mobile device, the network device containing a light source adapted to present a coded representation of the status of the network device via the light source activation sequence, wherein each light source activation sequence comprises a pattern that includes one or more of a blinking frequency and a color pattern;
decoding the light source activation sequence to the status of the network device with the mobile device; and
displaying the status of the network device and corresponding remediation information on a display of the mobile device.

15. The method of claim 14, wherein the mobile device decodes the light source activation sequence between about four to about five seconds.

16. The method of claim 14, wherein displaying the status of the network device comprises displaying virtual graphics indicating the status of the network device overlaid a captured image of the network device.

17. The method of claim 14, further comprising the mobile device transmitting the status of the network device to a remote monitoring system for further troubleshooting and analysis.

18. The method of claim 17, wherein the remote monitoring system is a cloud-based services system that bi-directionally communicates with the mobile device.

19. A non-transitory machine-readable medium having instructions stored therein, which when executed by a processor, cause the processor to perform operations, the operations comprising:
detecting a status of a network device;
associating the status of the network device with a light source activation sequence, wherein the light source activation sequence comprises a blinking frequency corresponding to the status of the network device;
in response to the association of the status of the network device with the light source activation sequence:
communicating the light source activation sequence to at least one light source of the network device; and
activating the at least one light source of the network device based on the communicated light source activation sequence.

20. The machine-readable medium of claim 19, wherein activating the at least one light source of the network device comprises selecting at least one radio, system, or power light-emitting diode to emit the light source activation sequence.
